(19) United States
(12) Patent Application Publication
(10) Pub. No.: US 2019/0370368 A1
(43) Pub. Date: Dec. 5, 2019

(54) DATA CONSISTENCY VERIFICATION METHOD AND SYSTEM MINIMIZING LOAD OF ORIGINAL DATABASE

(71) Applicant: Warevalley Co., Ltd., Seoul (KR)

(72) Inventors: In ho KIM, Goyang-si (KR); Yeong gu KWON, Seoul (KR); Woo june LEE, Gwangmyeong-si (KR)

(21) Appl. No.: 16/133,415

(22) Filed: Sep. 17, 2018

(30) Foreign Application Priority Data
May 31, 2018 (KR) 10-2018-0062876

(51) Int. Cl. G06F 17/30; G06F 11/14

(52) U.S. Cl. CPC G06F 17/30371; G06F 17/30368; G06F 17/30575; G06F 11/1471; G06F 17/30598

(57) ABSTRACT

Disclosed herein are a data consistency verification method and a system therefor, which are capable of efficiently verifying consistency of a large amount of data while minimizing a load of a source database by collecting and analyzing patterns of data changes in the source database, classifying the patterns of data changes into a time value or a numerical value range of a data change column, and grouping and comparing the classified patterns of data changes. The data consistency verification system includes a change data extraction part configured to extract packets between a client and an operating server which operates a source database, or extract change data from a transaction log or trigger information, a pattern analyzer configured to analyze a pattern of the change data extracted by the change data extraction part to generate data manipulation language (DML) change pattern bit set data storing change information, a rule engine module configured to determine a rule from the DML change pattern bit set data to generate a consistency profile, and a consistency execution module configured to perform consistency verification according to the consistency profile of the rule engine module. In accordance with the present invention, there is an effect of being capable of efficiently verifying consistency of a large amount of data while minimizing a load of a source database by tracking patterns of data changes in the source database and grouping and comparing regions in which a change largely occurs. Further, in accordance with the present invention, even when a task is being performed in a target database, data consistency is identically maintained as in the source database, there is an advantage of being capable of rapidly accurately processing a task.

### CROSS-REFERENCE TO RELATED APPLICATION

This application claims priority to and the benefit of Korean Patent Application No. 10-2018-0062876, filed on May 31, 2018, the disclosure of which is incorporated herein by reference in its entirety.

### BACKGROUND

### 1. Field of the Invention

The present invention relates to a data consistency verification method and a system therefor, which verify whether data of a source database and a replication database are consistent in a database operation system which operates a plurality of identical databases, and more particularly, to a data consistency verification method and a system therefor, which are capable of efficiently verifying a large amount of data while minimizing a load of a source database by collecting and analyzing change patterns of data of the source database and discriminating, grouping, and comparing the change patterns into a time value or a numerical value range of a data change column.

### 2. Discussion of Related Art

In the information age, large amounts of data are generated in various fields such as electronic commerce, Internet banking, Internet shopping malls, and the like, and accordingly, the same data is used for business purposes due to the use of various databases and data replication or migration between databases. During such data replication or migration, a data loss or damage to data may occur so that an efficient operating method is needed to ensure data reliability.

In order to ensure reliability of data consistency during data replication or migration between a source database and a target database, all or a part of data of the source database and the target database are conventionally fetched and the data is entirely compared in a row unit to check and maintain the data consistency.

However, since such a row-based data consistency verification method generates a large amount of loads in a source database having an online transaction processing (OLTP) characteristic, there is a problem in that a business processing system is slowed down. Consequently, verification for data consistency is not properly performed in an actual operation environment such that there occurs a case in which, a task is performed in a target database, a correct task cannot be performed due to the problem of data consistency.

Korean Patent Laid-Open Application No. 10-2009-0001955 discloses a method for managing property of data interfacing by using enterprise application integration, and Korean Patent Registration No. 10-1553712 discloses a distributed storage system for maintaining data consistency based on a log, and method for the same, in which a log is generated for an operation which cannot be performed by a failure node and an operation is performed on the basis of the generated log, thereby maintaining data consistency.

### SUMMARY OF THE INVENTION

The present invention is directed to a method and a system for efficiently verifying consistency of a large amount of data in a short period of time while minimizing a load of a source database in order to resolve the problem of data inconsistency which may occur during database replication or migration.

According to an aspect of the present invention, there is provided a data consistency verification system including a change data extraction part configured to extract packets between a client and an operating server which operates a source database, or extract change data from a transaction log or trigger information, a pattern analyzer configured to analyze a pattern of the change data extracted by the change data extraction part to generate data manipulation language (DML) change pattern bit set data storing change information, a rule engine module configured to determine a rule from the DML change pattern bit set data to generate a consistency profile, and a consistency execution module configured to perform consistency verification according to the consistency profile of the rule engine module.

The change data extraction part may be one among a sniffing module configured to extract structured query language (SQL) change data by replicating packet data from a switch or a tap device in a network environment, a proxy module configured to extract the SQL change data while relaying network packets, a transaction log module configured to extract the change data by fetching a transaction log, which is generated for recovery, from a data base management system (DBMS) of a first operating server, and a module configured to extract the change data with a trigger function capable of leaving change data history information.

The pattern analyzer may fetch a target analysis table list, fetch the change data from a queue storage, generate the DML change pattern bit set data, and store the DML change pattern bit set data in an internal storage.

According to another aspect of the present invention, there is provided a data consistency verification method including a first operation of extracting, by a change data extraction part, a packet between a client and an operating server which operates a source database, or extracting change data from a transaction log or trigger information, a second operation of analyzing, by a pattern analyzer, a pattern of the change data extracted in the first operation to generate data manipulation language (DML) change pattern bit set data storing change information, a third operation of determining, by a rule engine module, a rule from the DML change pattern bit set data to generate a consistency profile, and a fourth operation of performing, by a consistency execution module, consistency verification according to the consistency profile of the rule engine module.

The fourth operation may include fetching target table information and the consistency profile, measuring a load of the source database to determine whether the consistency verification is executable, setting a degree of parallelism of a dump module, executing a dump module to extract data from the source database and a target database, generating consistency data on the basis of a group row checksum algorithm (GRCA), executing a comparison module to check data consistency, and when inconsistency is detected and recovery data is present, executing a recovery module to perform data synchronization recovery.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is an overall block diagram of a consistency verification system according to an embodiment of the present invention;

FIG. 2 is an overall flowchart illustrating a consistency verification procedure by the consistency verification system according to the embodiment of the present invention;

FIG. 3 is a flowchart illustrating an operation of a sniffing module according to the embodiment of the present invention;

FIG. 4 is a flowchart illustrating an operation of a proxy module according to the embodiment of the present invention;

FIG. 5 is a flowchart illustrating an operation of a transaction log module according to the embodiment of the present invention;

FIG. 6 is a flowchart illustrating an operation of a trigger module according to the embodiment of the present invention;

FIG. 7 is a flowchart illustrating an operation of a pattern analysis module according to the embodiment of the present invention;

FIG. 8 is a flowchart illustrating an operation of a rule engine module according to the embodiment of the present invention;

FIG. 9 is a flowchart of a group row checksum algorithm (GRCA) according to the embodiment of the present invention;

FIG. 10 is a flowchart illustrating an operation of a consistency execution module according to the embodiment of the present invention;

FIG. 11 is a flowchart illustrating an operation of a dump module according to the embodiment of the present invention;

FIG. 12 is a flowchart illustrating an operation of a comparison module according to the embodiment of the present invention; and

FIG. 13 is a flowchart illustrating an operation of a recovery module according to the embodiment of the present invention.

### DETAILED DESCRIPTION OF EXEMPLARY EMBODIMENTS

The above and other technical objects, features, and advantages of the present invention will become more apparent from preferred embodiments of the present invention, which are described below, when taken in conjunction with the accompanying drawings. The following embodiments are merely illustrative of the present invention and are not intended to limit the scope of the present invention.

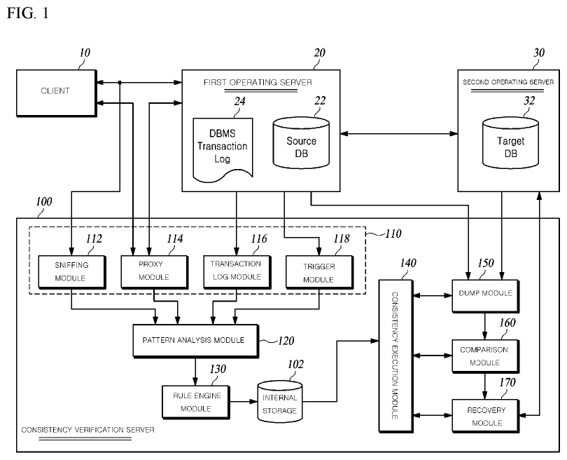

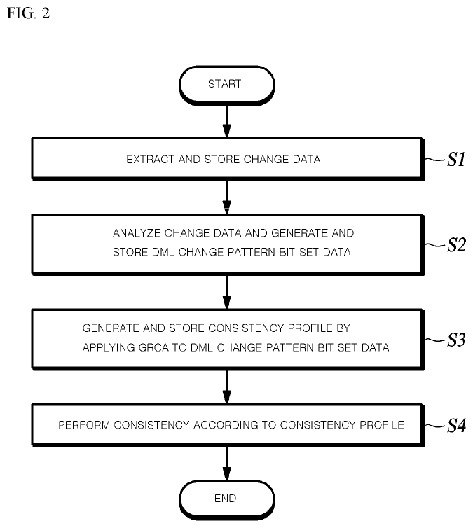

FIG. 1 is an overall block diagram of a consistency verification system according to an embodiment of the present invention, and FIG. 2 is an overall flowchart illustrating a consistency verification procedure by the consistency verification system according to the embodiment of the present invention.

As shown in FIG. 1, the consistency verification system according to the embodiment of the present invention includes a client 10, a first operating server 20 for operating a source database 22, a second operating server 30 for operating a target database 32, and a consistency verification server 100 for verifying data consistency between the source database 22 and the target database 32. The client 10 may directly access the first operating server 20 to transmit and receive structured query language (SQL) packets or may access the first operating server 20 through a proxy module 114 to transmit and receive SQL packets. During operation, the first operating server 20 generates a data base management system (DBMS) transaction log 24.

As shown in FIG. 1, the consistency verification server 100 includes an internal storage 102 for storing various data, a sniffing module 112, the proxy module 114, a transaction log module 116, a trigger module 118, a pattern analysis module 120, a rule engine module 130, a consistency execution module 140, a dump module 150, a comparison module 160, and a recovery module 170. The internal storage 102 may include a plurality of queues. Here, the sniffing module 112, the proxy module 114, the transaction log module 116, and the trigger module 118 correspond to a change data extraction module 110.

As shown in FIG. 2, the consistency verification system of the present embodiment sequentially performs a change data extracting operation S1 of extracting change data from the change data extraction module 110 and storing the change data in a queue, a data manipulation language (DML) change pattern bit set data generating operation S2 of fetching the change data from the queue, analyzing the change data, generating a DML change pattern bit set data, and storing the DML change pattern bit set data in the internal storage 102, a consistency profile generating operation S3 of generating a consistency profile by applying a group row checksum algorithm (GRCA) in a table unit, and a consistency executing operation S4 for actually performing consistency according to the consistency profile.

Referring to FIG. 2, in the change data extracting operation S 1, after the sniffing module 112 is started, the proxy module 114 is started, the transaction log 116 is started, the trigger module 118 is started, the change data is extracted and stored in the queue.

In the DML change pattern bit set data generating operation S2, the pattern analysis module 120 is executed, the change data is fetched from the queue storage and is analyzed, and then the DML change pattern bit set data is generated and stored in the internal storage 102.

In the consistency profile generating operation S3, the rule engine module 130 is started, bit mask data of a table unit is fetched, and the GRCA is applied to the bit mask data in a table unit to generate and store the consistency profile.

In the consistency executing operation S4, the dump module 150 is started, data is extracted from the source and target databases 22 and 32 to generate the consistency data, and then the comparison module 160 is started to perform a data consistency check. Then, when recovery data is present, the recovery module 170 performs data synchronization recovery.

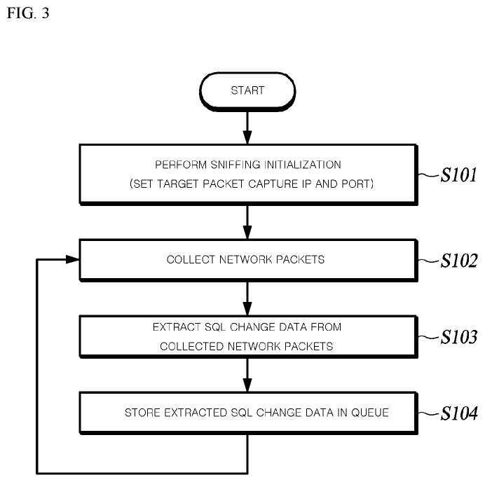

Referring to FIG. 1, the sniffing module 112 is a module for replicating packet data in a switch or tap device in a network environment. The sniffing module 112 serves to extract change data by analyzing a DBMS packet and provide data required for consistency to the pattern analysis module 120. As shown in FIG. 3, the sniffing module 112 performs sniffing initialization, collects network packets, extracts structured query language (SQL) change data from the collected network packets, and stores the extracted SQL change data in the queue (S101 to S104).

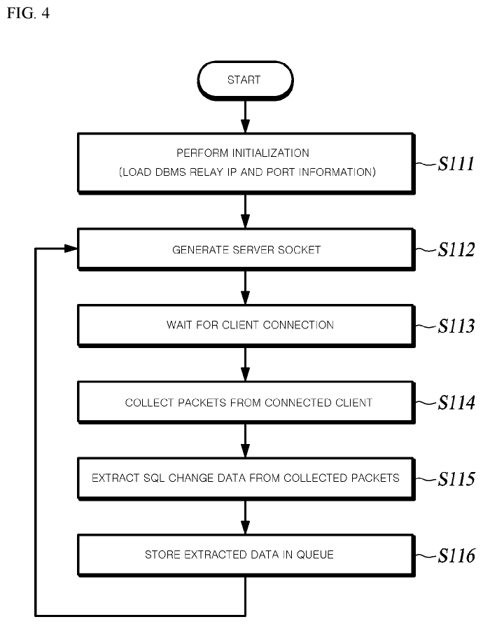

The proxy module 114 basically serves to relay the network packets. In this embodiment, the proxy module 114 provides the pattern analysis module 120 with change data information required for consistency verification during relaying packets of a DBMS. As shown in FIG. 4, after performing initialization, the proxy module 114 generates a server socket and is in waiting for a client connection (S111 to S113). Then, the proxy module 114 collects packets transmitted from the connected client to the DBMS, extracts the SQL change data from the collected packets, and stores the extracted data in the queue (S114 to S116).

The transaction log module 116 serves to fetch and analyze a transaction log generated for recovery from the DBMS of the first operating server 20 and provides change data (DML) information required for consistency to the pattern analysis module 120. Here, the change data (DML) information includes INSERT, UPDATE, DELETE, and the like. As shown in FIG. 5, the transaction log module 116 performs initialization for fetching connection DBMS information and final processing transaction log and then extracts the change data information from the DBMS transaction log 24 (S121 and S122). Then, the transaction log module 116 stores the extracted change data in a data queue (S123).

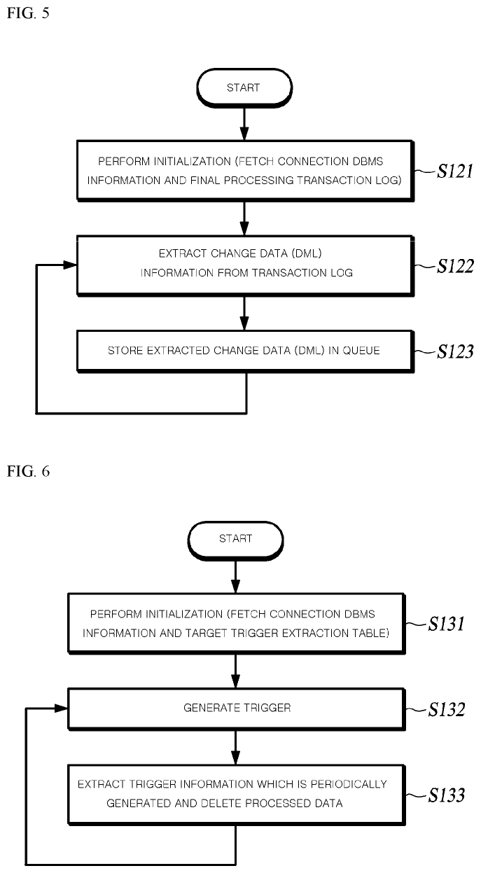

Meanwhile, all DBMSs provide a trigger function of leaving change data history information. In the present embodiment, the trigger module 118 serves to provide the change data information to the pattern analysis module 120 according to the trigger function. As shown in FIG. 6, the trigger module 118 performs initialization for fetching the connection DBMS information and a target trigger extraction table, and when an existing generated trigger is not present, the trigger module 118 generates a trigger, extracts trigger information which is periodically generated, and deletes the processed data (S131 to S133). At this point, the trigger generation is such that changed column information is stored as 1 or 0 in a trigger table at the time of INSERT and UPDATE.

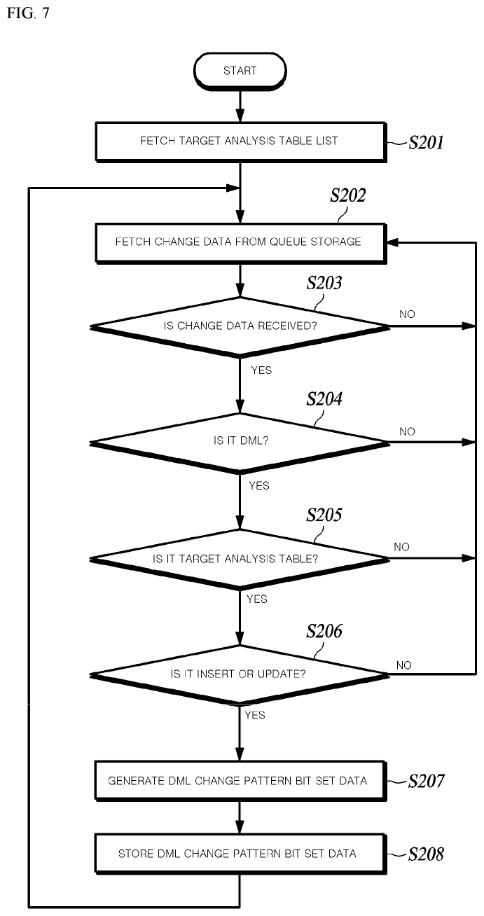

The pattern analysis module 120 analyzes the change data information collected in at least one among the sniffing module 112, the proxy module 114, the transaction log module 116, and the trigger module 118, generates DML change pattern bit set data, and stores the DML change pattern bit set data in the internal storage 102. As shown in FIG. 7, the pattern analysis module 120 fetches a target analysis table from a target analysis table list and then fetches the change data from a queue (S201 and S202). Subsequently, when it is the change data, a DML, and the target analysis table, the pattern analysis module 120 determines INSERT or UPDATE, generates pattern analysis bit mask data, and stores the DML change pattern bit set data in the internal storage 102 (S203 to S208).

Here, attribute values of the DML change pattern bit set data are shown in the following table, Table 1.

TABLE 1

| | | | |
|---|---|---|---|
| Sequence | | Attribute | |
| number | Attribute name | value | Note |

| | | |
|---|---|---|
| 1 | Table object number | |
| | (identifier value) | |
| 2 | Data generation time | |
| 3 | DML type | |
| 4 | Representing changed | 1 indicates change, 0 |
| | columns in bits | indicates no change |
| 5 | Issuing (date + | Used for self-pattern |
| | sequence number) | analysis |

In order to store the binary data of Table 1 as a single pattern ROW, it is stored in the form of a BASE 64 encoded string and is utilized as analysis data.

The rule engine module 130 analyzes the DML change pattern bit set data, which is collected and stored by the pattern analysis module 120, generates a final consistency execution profile in a table unit, and stores the final consistency execution profile in the internal storage 102. Then, the rule engine module 130 measures an amount of data generation in a table unit, day unit, and time unit and a total amount of data generation, generate load generation information of the source database, and stores the load generation information in the internal storage 102. Here, a method of minimizing a load of a GRCA source database is proposed. When the method is executed with GRCA, it is possible for the method to rapidly operate by minimizing a load with a data extraction method excluding an alignment load of the source database and simplifying a comparison function when data consistency verification is performed.

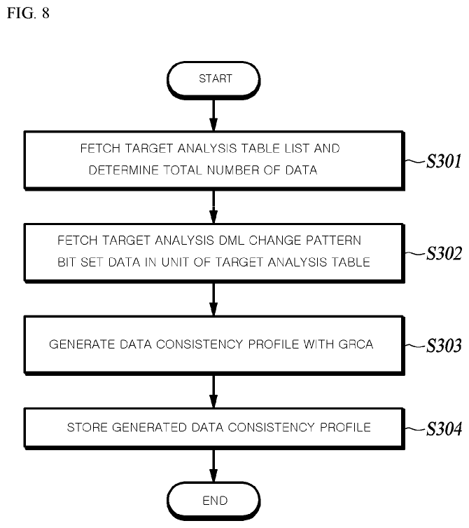

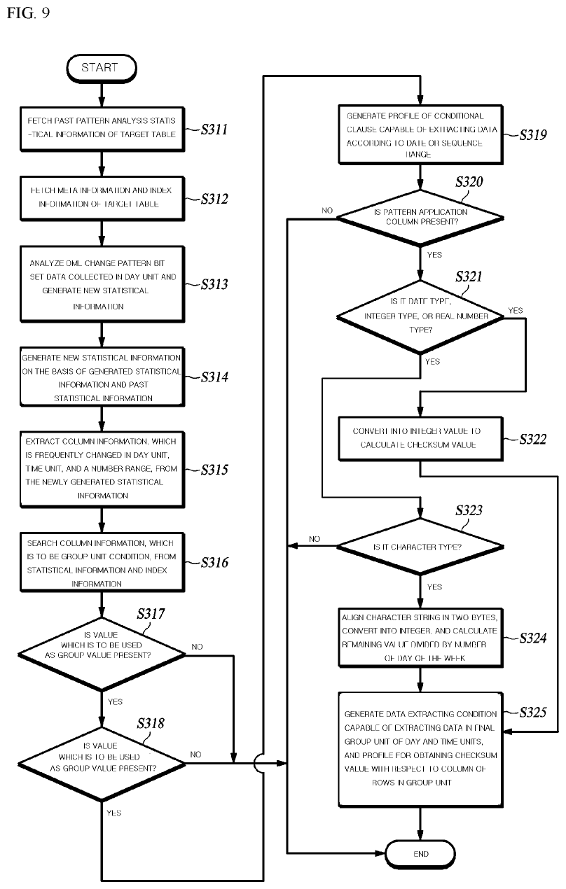

Referring to FIG. 8, the rule engine module 130 fetches a target analysis table list from the target analysis table, determines a total number of data, and then fetches target analysis DML change pattern bit set data in a unit of the target analysis table (S301 and S302). Then, the rule engine module 130 generates a data consistency profile with GRCA and stores the generated data consistency profile in the internal storage 102 (S303 and S304). Here, the procedure for generating the data consistency profile with GRCA algorithm is shown in FIG. 9.

Referring to FIG. 9, past pattern analysis statistical information of a target table is fetched, and meta information and index information of the target table are fetched (S311 and S312). Next, a DML change pattern bit set data, which is not analyzed, is analyzed to generate statistical information, and new statistical information is generated on the basis of the generated statistical information and past statistical information (S313 and S314). Column information, which is frequently changed in day unit, is extracted from the newly generated statistical information (S315). In this case, one or more different column type conditions or three or less different column type conditions are selected.

Then, column information which may become a group unit condition is searched from the statistical information and the index information (S316). Here, the column information may be a continuously increasing value or range value among a date, a sequence, a number, and a character. Then, it is determined whether a value which will be used as a group value is present, and a profile of a conditional clause capable of extracting data according to a date or a sequence range is generated (S317 to S319).

Thereafter, it is determined whether a pattern application column is present, and when it is a date type, an integer type, or a real number type, it is converted into an integer value, and a checksum value, i.e., a plus operation is performed (S320 to S322). When it is a character type, a character string is aligned in two bytes and is converted to an integer, and then the remaining value divided by a number of day of the week is calculated (S323 and S324). Then, a data extracting condition capable of extracting data in a final group unit of time unit, and a profile for obtaining a checksum value with respect to a column of ROWs in a group unit are generated (S325).

Referring back to FIG. 1, when consistency execution is requested, the consistency execution module 140 executes and manages an actual consistency operation on the basis of the GRCA and the profile which are generated in the rule engine module 130. The consistency execution is started by the dump module 150 at the time when the load is minimized by obtaining a load value of the source database, which is collected by the rule engine module 130, This is a preliminary task to minimize the load of the source database.

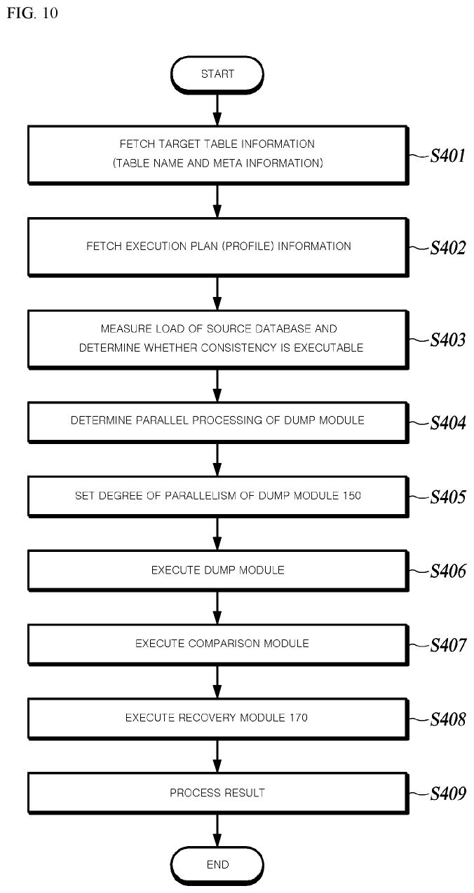

As shown in FIG. 10, the consistency execution module 140 fetches target table information such as the table information and the meta information, fetches execution plan (profile) information, measures the load of the source database 22, and determines whether consistency is executable (S401 to S403). Next, a parallel processing of the dump module 150 is determined, a degree of parallelism of the dump module 150 is set, and the dump module 150 is executed (S404 to S406). After the comparison module 160 is executed, the recovery module 170 is executed to process a result (S407 to S409).

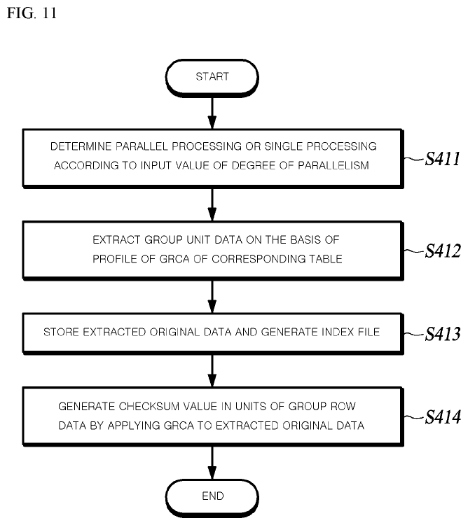

The dump module 150 is operated on the basis of the data of the target consistency table and the profile information generated in the rule engine module 130. First, corresponding row data is extracted from the source and target databases 22 and 32, a checksum is generated and stored by applying the GRCA, the row data extracted for recovery is group-and processed with the GRCA and is stored, and an index file for a search is generated. For the purpose of recovery, original data is stored in a group unit with the GRCA, thereby providing a quick search function during recovery. As shown in FIG. 11, the dump module 150 determines a parallel processing or a single processing according to an input value of the degree of parallelism and extracts a group unit data on the basis of the profile of the GRCA of the corresponding table (S411 and S412). The extracted original data is stored and the index file is generated (S413). Then, the GRCA is applied to the extracted original data to generate a checksum value in units of group ROW data (S414).

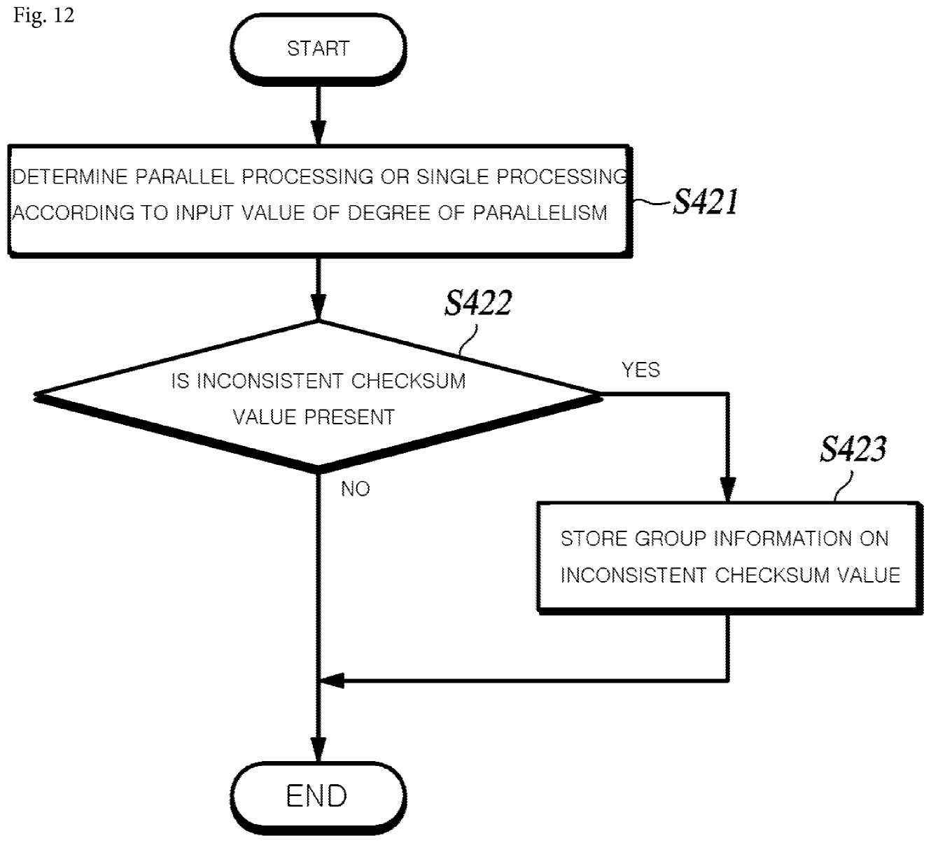

The comparison module 160 compares GRCA data of the source database 22 with GRCA data of the target database 32, which are generated by the dump module 150, determines whether the GRCA data are consistent. When the GRCA data are inconsistent, the comparison module 160 searches a corresponding inconsistent row from original and target data files to store the corresponding inconsistent row as a recovery data file. At this point, when the data is more than 30% of the total data or the original data of the target table is less than one million, and data inconsistency occurs, a migration recovery mode is executed. As shown in FIG. 12, the comparing module 160 compares a group row checksum value of the source database 22 with a group row checksum value of the target database 32 to perform data consistency inspection (S421). Then, when an inconsistent checksum value is determined as being present, the comparing module 160 stores group information on the inconsistent checksum value (S422 and 423).

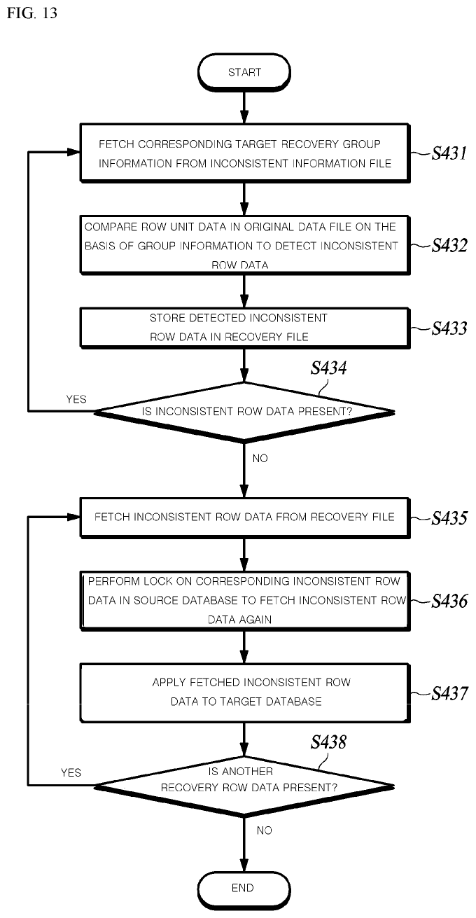

The recovery module 170 operates when there is a data recovery signal from the compare module 160. After performing LOCK on a row of a corresponding recovery table in the source database 22, the recovery module 170 synchronizes the row data extracted from the source database 22 with the target database 32. LOCK utilizes the corresponding DBMS table or a LOCK function in a row unit. As shown in FIG. 13, the recovery module 170 fetches corresponding target recovery group information from an inconsistent information file and compares row unit data in the original data file on the basis of the corresponding target recovery group information to detect inconsistent row data (S431 and S432). The recovery module 170 stores the detected inconsistent row data in the recovery file (S433). When inconsistent row data is no more present after such an operation is repeated, the recovery module 170 fetches the inconsistent row data from the recovery file and performs LOCK on the corresponding inconsistent row data in the source database 22 to fetch the inconsistent row data again (S434 to S436). Subsequently, the recovery module 170 applies the fetched inconsistent row data to the target database 32, and when a recovery ROW is present, the recovery module 170 repeats the above-described operations (S437 and S438).

In accordance with the present invention, patterns of data changes in a source database are collected, analyzed, classified into a time value or a numerical value range of a data change column, grouped and compared such that there is an effect of being capable of efficiently verifying consistency of a large amount of data while minimizing a load of the source database.

Further, in accordance with the present invention, even when a task is being performed in a target database, data consistency is identically maintained as in the source database, there is an advantage of being capable of rapidly accurately processing a task.

While the present invention have been described with reference to the exemplary embodiments shown in the drawings, those skilled in the art will appreciate that various modifications and equivalent other embodiments can be derived without departing from the scope of the present invention.

What is claimed is:

1. A data consistency verification system minimizing a load of a source database, the data consistency verification system comprising:
a change data extraction part configured to extract packets between a client and an operating server which operates a source database, or extract change data from a transaction log or trigger information;
a pattern analyzer configured to analyze a pattern of the change data extracted by the change data extraction part to generate data manipulation language (DML) change pattern bit set data storing change information;
a rule engine module configured to determine a rule from the DML change pattern bit set data to generate a consistency profile; and
a consistency execution module configured to perform consistency verification according to the consistency profile of the rule engine module.

2. The data consistency verification system of claim 1, wherein the change data extraction part is one among a sniffing module configured to extract structured query language (SQL) change data by replicating packet data from a switch or a tap device in a network environment, a proxy module configured to extract the SQL change data while relaying network packets, a transaction log module configured to extract the change data by fetching a transaction log, which is generated for recovery, from a data base management system (DBMS) of a first operating server, and a module configured to extract the change data with a trigger function capable of leaving change data history information.

3. The data consistency verification system of claim 1, wherein the pattern analyzer fetches a target analysis table list, fetches the change data from a queue storage, generates the DML change pattern bit set data, and stores the DML change pattern bit set data in an internal storage.

4. A data consistency verification method of a consistency verification server including a change data extraction part, a pattern analyzer, a rule engine module, and a consistency execution module, the data consistency verification method comprising:
a first operation of extracting, by the change data extraction part, a packet between a client and an operating server which operates a source database, or extracting change data from a transaction log or trigger information;
a second operation of analyzing, by the pattern analyzer, a pattern of the change data extracted in the first operation to generate data manipulation language (DML) change pattern bit set data storing change information;
a third operation of determining, by the rule engine module, a rule from the DML change pattern bit set data to generate a consistency profile; and
a fourth operation of performing, by the consistency execution module, consistency verification according to the consistency profile of the rule engine module.

5. The data consistency verification system of claim 4, wherein the fourth operation includes:
fetching target table information and the consistency profile;
measuring a load of the source database to determine whether the consistency verification is executable;
setting a degree of parallelism of a dump module;
executing a dump module to extract data from the source database and a target database;
generating consistency data on the basis of a group row checksum algorithm (GRCA);
executing a comparison module to check data consistency; and
when inconsistency is detected and recovery data is present, executing a recovery module to perform data synchronization recovery.
